(19) United States
(12) Patent Application Publication
(10) Pub. No.: US 2017/0081171 A1
(43) Pub. Date: Mar. 23, 2017

(54) ERGONOMIC BRIDLE FOR EQUINES

(71) Applicant: Gustavo SUGLIANO OLIVERA, Atlantida (UY)

(72) Inventor: Gustavo SUGLIANO OLIVERA, Atlantida (UY)

(21) Appl. No.: 14/858,432

(22) Filed: Sep. 18, 2015

(51) Int. Cl. B68B 1/04; B68B 1/06

(52) U.S. Cl. CPC B68B 1/04; B68B 1/06

(57) ABSTRACT

Ergonomic bridle for equines, formed by a band, composed of lateral pieces connected by means of any joining element to an upper bridge and frontal bridge; connected to the lateral pieces by means of any joining element, the crescents are provided which incorporate, at the ends thereof, a belt for the joining to the bit; a nasal band which is connected to a throatband, said throatband being formed by two curved belts which are joined together by the area of the lower maxilla of the equine.

### BACKGROUND OF THE INVENTION

Up to now, there exists one single traditional system for supporting the bits of equines.

The existing traditional design generates various problems which have been hitherto unresolved: hindering the rear vision of the equines, they exert increased pressure in the cervical, trachea and throat areas.

In the prior art, no ergonomic bridle for equines is found having the technical characteristics which are described in the present patent for an invention.

### DESCRIPTION OF THE INVENTION

The object of the present invention is to provide a novel ergonomic bridle for equines which provides improved ergonomy, optimizing the anatomic adaptability, providing physical benefits, relieving the cervical movements, the ears, the facial muscles in general and also increasing the visual range.

This novel ergonomic bridle for equines has particular application in the equestrian sector, where, due to the circumstances, it is necessary to provide a bridle with said characteristics.

Ergonomic bridle for equines, essentially composed of a band, said band being formed in turn by lateral pieces connected by means of any joining element to the upper bridge and frontal bridge.

The crescents, which incorporate, at the ends thereof, a belt for the joining to the bit are provided connected to the lateral pieces and by means of any joining element.

A nasal band which is connected to a throatband, said throatband being formed by two curved belts which are joined to each other at the area of the lower maxilla of the equine.

The present invention provides the following advantages:

The band of the bridle gives movement to the ears of the animal by releasing the sixteen muscles which move them, such that the normal development of one of the most important senses of the equine, which is hearing, is achieved which complements the vision which with this new bridle increases the rear and perimetrical perception.

The curved and rigid pieces, due to the particular form thereof are distanced from the eyes, giving a free movement, avoiding the normal discomforts, allowing it to be located in a more comfortable area for the equine, eliminating the hindering sensation in the near peripheral vision and the pressure of the facial nerves.

This novel ergonomic bridle for equines is regulatable in different positions.

### BRIEF DESCRIPTION OF THE DRAWING

In order to complement the description and with the aim of aiding a better understanding of the characteristics of the invention, a series of figures accompany the present specification as an integral part of the same, in which the following is represented in an illustrative and non-limiting manner:

FIG. 1: exploded view of the elements which form the ergonomic bridle for equines.

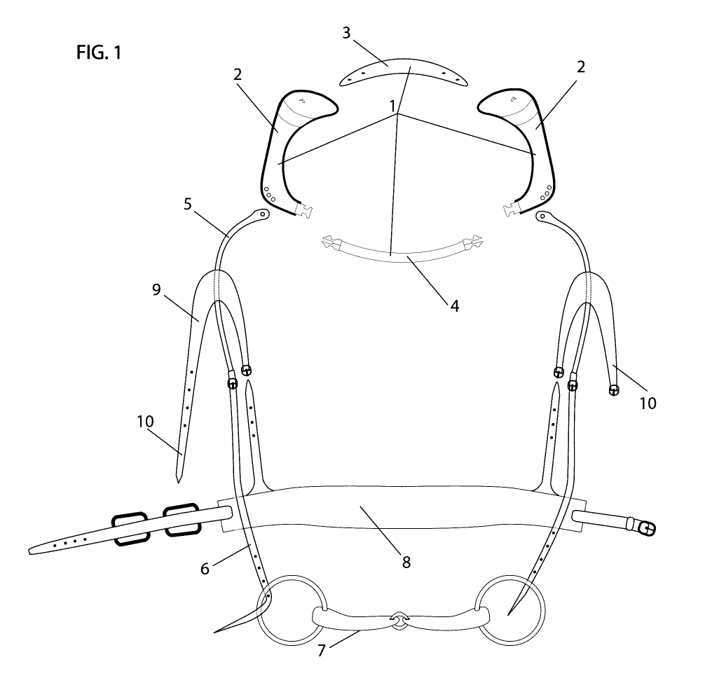

FIG. 2: lateral perspective view of an exemplary use of the ergonomic bridle for equines.

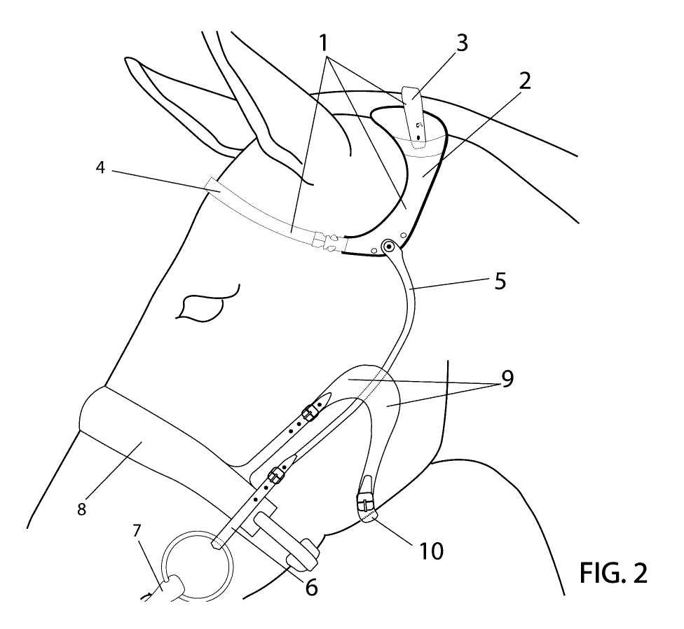

### PREFERRED EMBODIMENT OF THE INVENTION

As is possible to observe in the attached figures, the ergonomic bridle for equines is composed of a band (1), said band being formed in turn by lateral pieces (2) connected by means of any joining element to the upper bridge (3) and frontal bridge (4).

The crescents (5), which incorporate, at the ends thereof, a belt (6) for the joining to the bit (7) are provided connected to the lateral pieces (2) and by means of any joining element.

A nasal band (8) which is connected to a throatband (9), said throatband being formed by two curved belts (10) which are joined to each other at the area of the lower maxilla of the equine.

With the nature of the present invention as well as a form of putting it into practice having been sufficiently described, it should be added that said invention can undergo variations in form and materials, provided said alterations do not substantially vary the characteristics which are claimed below.

What is claimed is:

1. An ergonomic bridle for equines, characterized in that it is composed of a band (1), said band being formed in turn by lateral pieces (2) connected by means of any joining element to the upper bridge (3) and frontal bridge (4); the crescents (5), which incorporate, at the ends thereof, a belt (6) for the joining to the bit (7) are provided connected to the lateral pieces (2) by means of any joining element; a nasal band (8) which is connected to a throatband (9), said throatband being formed by two curved belts (10) which are joined to each other at the area of the lower maxilla of the equine.
